(19) United States
(12) Patent Application Publication
(10) Pub. No.: US 2009/0213435 A1
(43) Pub. Date: Aug. 27, 2009

(54) Certified inbound facsimile service

(76) Inventor: Larry Cohen, Silver Spring, MD (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/072,041

(22) Filed: Feb. 22, 2008

(51) Int. Cl. H04N 1/00; G06F 15/16

(52) U.S. Cl. 358/402; 709/206

(57) ABSTRACT

Method for monitoring delivery of e-mail messages includes delivering an e-mail message to a primary, recipient, determining the time at which the e-mail message was delivered to the primary recipient, and determining whether the primary recipient reads the e-mail message within a primary maximum time frame. When the primary recipient does not read the e-mail message within the primary maximum time frame, delivering a copy of the e-mail message to a secondary recipient, determining the time at which the e-mail message was delivered to the secondary recipient, and determining whether the secondary recipient reads the e-mail message within a secondary maximum time frame. When both the primary and secondary recipients do not read the e-mail message within the secondary maximum time frame, appropriate action is taken such as notifying a predesignated available recipient to enable the available recipient to attend to facilitating a response to the e-mail message.

### FIELD OF THE INVENTION

The present invention relates generally to methods, systems and computer programs for certifying reading of e-mail messages, in particular, inbound facsimile messages which have been converted to e-mail messages.

More particularly, the present invention relates to methods, systems and computer programs for certifying that facsimile messages converted to e-mail messages and delivered to one or more intended recipients via an e-mail client are read within assigned time frames and if not, notifying an alternate recipient of the fact that the facsimile message has not been read within the assigned time frame to enable a response by the alternate recipient to enable, and possibly ensure, reading and possible response to the facsimile message.

### BACKGROUND OF THE INVENTION

The transmission of a document via electronic means from one device to a remotely situated device is commonly referred to as facsimile or “fax” transmission and is believed to have been invented over 100 years ago. However, facsimile service did not become mainstream in the business workplace until the early 1960's when inexpensive six-minute fax machines were introduced that operated over the standard telephone network. In the late 1970's, Group III fax machines with only partial minute transmission capabilities were available and these fax machines firmly established facsimile transmissions in business use.

In a business setting, fax machines tend to be located in common areas so that they can be used by large groups of workers for sending and receiving documents. Most businesses also publish and otherwise disseminate their fax numbers so that business partners, customers and clients can easily send documents to them. In most cases, reception of such documents is handled by designated office staff (receptionists, group secretaries, etc.), who process the incoming or inbound fax transmissions, possibly docket them, and then distribute them to the person or people responsible for any action responsive to the fax transmission, e.g., the designated recipient(s) of the fax transmission.

Nowadays, e-mail service, as well as priority and overnight delivery services, has largely replaced the need for fax machines and fax transmissions. However, in some major, time critical business applications such as mortgage applications, security buy/sell orders, medical prescriptions and other procedures where a legal signature may be required, fax transmissions remain a viable and necessary service.

Transmissions between sending and destination fax machines are standardized by CCITT and other professional industry groups. In this regard, fax machines have integral identifiers to allow senders to verify that the dialed connection at the sending fax machine has reached the desired destination fax machine. The sender's identity may also be printed on the received fax image, usually in the top margin, and the identity of the receiving fax machine may be available to the sender by printing journal or transmission records from the sending fax machine.

These identifiers allow for reliable and often legally binding aspects of sending faxed documents between businesses since reception of the faxed document by the receiving fax machine is provided to the sending fax machine. In certain situations, when a document is transmitted between fax machines, any responsibility created by the document is thus transferred from the sender to the recipient when the sending fax machine verifies the proper termination of the transmission process and thus delivery of the faxed document to the recipient's fax machine, i.e., the receiving fax machine. Therefore, it is often the recipient's responsibility, or the recipient's employer's responsibility, to insure that proper and timely action is taken after a faxed document is received to address whatever issues are raised in the faxed document.

Instead of sending a facsimile transmission from a fax machine, it is also possible to use what is commonly referred to as a “Fax PC card” which is a card connected to a computer and capable of transmitting documents created in various programs using that computer via a facsimile transmission. Use of a Fax PC card precludes having a handwritten signature on the document, which would still require the document to be printed out, signed and then sent using a traditional fax machine.

By eliminating the need for a dedicated fax machine to initiate a fax transmission, fax PC cards allow “service providers” to offer facsimile-related services to others, often referred to as their “clients”. These service providers provide fax services to clients via Internet or dedicated communication lines, allowing the clients to create messages in various applications, and transmit them to the service provider for delivery to nominated or designated fax numbers. These applications require the service providers to report back to their clients about the disposition of the delivery of fax messages so that the clients can recognize, for example, which of their messages have been properly delivered to the intended, designated fax machines, and which have not reached their intended destination.

Various patent documents have been published relating to facsimile transmission delivery notification techniques. Some describe PC to fax transmission services including conversion of various application formats to fax images, and reporting of distribution results of these fax images back to the senders. Others describe improvements in the notification to the sending fax machine of the receipt of the fax message by the receiving fax message.

For example, Sugawara et al. (U.S. Pat. Appln. Publ. No. 2007/0153329) disclose an image communication apparatus and method wherein the user is notified of disposition of a message with the sending of a message disposition notification to the transmitter side from the receiver side. Bloomfield (U.S. Pat. Appln. Publ. No. 2005/0012965 and U.S. Pat. No. 6,025,931) discloses a fax to e-mail communication system in which the sender is provided with notification of the receipt of the fax. Tamura (U.S. Pat. Appln. Publ. No. 2002/0120700) discloses a method and apparatus for image communication with e-mail messages having receipt acknowledgment. Nielsen (U.S. Pat. No. 6,108,688) discloses a system for reminding a sender of an e-mail message if the recipient does not respond by a selected time sent by the sender, with a time/date selection noted. Henry (U.S. Pat. No. 6,424,426) discloses a fax-to-e-mail and e-mail-to-fax communications system wherein a confirmation page is incorporated.

None of these prior art message delivery notification techniques account for a situation where the intended recipient of a message receives but does not respond to the message within a predetermined time. Thus, it is conceivable that a sender may consider a message delivered to the intended recipient, which is the case, but the intended recipient has never read the message. This has the potential to cause significant problems when not only receipt of a fax message needs to be certified or established, but also reading of the message needs to be certified or established.

PC fax cards may also be used by service providers to receive calls from standard fax machines; and then store and retransmit the image to the intended recipient via other means, such as an attachment to an e-mail message. However, no current method exists to ensure that the recipient of the e-mail message actually reads the attached fax image.

### OBJECTS AND SUMMARY OF THE INVENTION

It is an object of the present invention to provide new and improved methods, systems and computer programs for certifying reading of e-mail messages, including e-mail messages which are derived from inbound facsimile messages.

In order to achieve this object and others, a method for monitoring delivery of e-mail messages in accordance with the invention includes delivering an e-mail message to a primary, intended recipient, determining the time at which the e-mail message was delivered to the primary recipient, and determining whether the primary recipient reads the e-mail message within a primary maximum time frame. When the primary recipient does not read the e-mail message within the primary maximum time frame, then the method entails delivering a copy of the e-mail message to at least one secondary recipient, determining the time at which the e-mail message was delivered to each secondary recipient, and determining whether any secondary recipient reads the e-mail message within a secondary maximum time frame. When both the primary and secondary recipients do not read the e-mail message within the secondary maximum time frame, then the method entails taking appropriate action in view of the non-reading of the e-mail message by the primary and secondary recipients, such as notifying a predesignated available recipient to enable the available recipient to attend to facilitating a response to the e-mail message.

When the method is implemented by a service provider for its client, the service provider can provide notification to the client when at least two of the client's employees do not respond to an e-mail message with a maximum allotted period of time for response. In this manner, an e-mail message is highly unlikely to be completely ignored and it is almost assured that a response thereto will be provided, if necessary. This is critical when the e-mail message is derived from a facsimile transmission which is time-sensitive.

To determine whether the primary and secondary recipients read the e-mail message, at least one activatable link may be inserted in the e-mail message. Each link is only activated when the recipient reads the e-mail message and by detecting the activation of the link, the time at which the e-mail message is read is determined. The link may be in the form of a request for an image from a web site which is required to read the e-mail message and it may be automatically activated when a recipient reads the e-mail message. Alternatively, the link might be one which must be manually activated by the recipient when reading the e-mail message, i.e., when there are no images in the e-mail message to be requested from a web site.

To optimize the possibility of the recipients reading the e-mail messages within the maximum time periods, the work hours, workdays and vacation schedule of the recipients are determined and the maximum time period includes only work hours. This aspect may be implemented independent of the specific action taken when the primary recipient does not respond to the e-mail within the primary maximum time frame. Thus, another method for monitoring delivery of e-mail messages includes determining work hours for the primary recipient, delivering an e-mail message to a primary, intended recipient, determining the time at which the e-mail message was delivered to the primary recipient, determining whether the primary recipient reads the e-mail message within a primary maximum time frame and considering only work hours of the primary recipient in the primary maximum time frame. When the primary recipient does not read the e-mail message within the primary maximum time frame, additional action is undertaken to enable and possibly ensure reading of the e-mail message by an alternate recipient, for example, but not limited to, the delivery of the e-mail message to a secondary recipient. Other possibilities include delivering the e-mail message to an alternate e-mail address of the primary recipient or notifying the primary recipient using means other than an e-mail message.

In one embodiment, each of the recipients is notified when they read the e-mail message of prior reading of the e-mail message by another recipient during the time when the e-mail message has been delivered to the multiple recipients. Notification may entail inserting an activatable link in the e-mail message and creating a ticker image in the e-mail message only after the link is activated which indicates the status of reading of the same e-mail message by any other recipients thereof. The ticker image is therefore not created when the e-mail is delivered but rather only the link to create the ticker image is included in the original, delivered e-mail message.

This feature may be applied in a method for monitoring delivery of e-mail messages independent of the application of the maximum time periods for the primary and secondary recipients as mentioned above. That is, in any application when the same e-mail message has been delivered to multiple recipients such that the recipients are able to read the e-mail message at the same time, notification can be provided in the e-mail message to each recipient of prior reading of the e-mail message by another recipient. This notification can be provided using the activatable link to create a ticker image as described above. Another, separate e-mail message does not have to be generated and sent to other recipients indicative of reading of the e-mail by one of the recipients. The invention therefore avoids duplicate responses to e-mails.

A system for monitoring delivery of e-mail messages derived from facsimile messages in accordance with the invention includes communications hardware which has at least one designated fax number and receives facsimile transmissions, at least one database including data about e-mail addresses of possible recipients of facsimile transmissions, and a processor coupled to the communications hardware and each database and arranged to convert each facsimile transmission into an e-mail message and deliver the e-mail message to at least one e-mail address of an intended, primary recipient of the facsimile transmission obtained from a database. The processor implements any of the methods described above. Thus, the processor may be arranged to record the time at which the e-mail message was delivered, determine whether the primary recipient reads the e-mail message within a maximum first time frame, if not, deliver a copy of the e-mail message to at least one secondary recipient, record the time at which the e-mail message was delivered to the at least one secondary recipient, determine whether the primary or secondary recipient reads the e-mail message within a maximum second time frame, and if not, notify an available recipient of the lack of reading of the e-mail message by both the primary and secondary recipients.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a schematic showing a system capable of certifying receipt of e-mail messages derived from fax transmissions in accordance with the invention.

FIG. 2 is a flow chart showing the general stages of a first embodiment of a method in accordance with the invention for certifying delivery of e-mail messages including those derived from fax transmissions.

FIG. 3 is a flow chart showing the manner in which delivery of an e-mail message is monitored in accordance with the invention.

FIG. 4 is a flow chart showing the manner in which each recipient of an e-mail message may be notified of a prior reading of the same e-mail message.

### DETAILED DESCRIPTION OF THE INVENTION

The description below relates primarily to the application of the invention in the context of a service provider providing fax delivery services to and/or on behalf of one of its clients, and more specifically for managing the reception of fax messages by employees of the client. However, the invention is equally applicable in other contexts wherein an entity wants to be able to certify delivery e-mail messages derived from inbound fax messages being transmitted to telephone numbers designated to receive fax messages.

The present invention originates from and incorporates a technique which replaces the need for a receiving or destination fax machine. That is, there is no physical fax machine which is assigned a telephone number and connects to a transmitting machine to print out a transmitted facsimile message. In a general application of this technique, a call to a designated fax number is intercepted and answered using Fax PC technology to receive a document fax image. When managed by the service provider, the call would be directed to its client and the service provider intercepts the call to the client, answers the call and receives the fax image of the document. This type of service provided by the service provider is often referred to as an “inbound fax service”. Management of inbound services by service providers started in the late 1980's.

In one implementation of managing inbound fax services, instead of a client publishing and otherwise disseminating fax numbers for multiple users or units in a single physical location, the service provider would provide one or more telephone numbers directed to equipment at its site and this number or these numbers would be provided by the client as its designated fax number or numbers for all of the units. Each telephone number may be assigned to a group of users or alternatively, each user may be assigned a unique telephone number. The telephone numbers dedicated for fax usage may be existing telephone numbers which can be ported to use by the service provider, or new telephone numbers assigned by the service provider. When incoming fax messages are sent to these numbers from third-party fax machines, the calls would be processed by a telephone network, and routed to the service provider. The telephone network signaling would supply the dialed number to the service provider, so that the service provider would know the identity of the “receiving” party the sender was trying to reach. The service provider's equipment would then answer the fax call and a Fax PC Card would handle the Group III fax protocol, and accept the fax page image or images. After the fax transmission is finished, the service provider would use a lookup table to determine how to forward the received fax image(s) to the client, i.e., review a table associating the identity of the receiving party with the manner in which the fax image(s) is to be provided to the receiving party. Usually, the fax image(s) are provided to the receiving party via e-mail and especially if the designated fax number is unique to the receiving party, in which case, the fax image(s) would be provided directly to the receiving party's e-mail address or addresses. Generally, the service provider handling inbound fax services serves the client alone and not the senders and thus does not manage data about the identity of the senders nor does it notify the senders of delivery of facsimile messages.

In summary, the process for delivery a fax message using a service provider for inbound fax services begins when the fax sender transmits the document from a fax machine (or via a PC) to a telephone number designated as a facsimile number. The telephone call is answered by the service provider's Fax PC card and the document image is accepted and stored electronically. The service provider looks up the desired delivery method associated with the intended recipient, which is usually one or more e-mail addresses, and delivers the fax image, typically as an attachment to a message sent to the e-mail address or addresses. The recipient receives the fax image, e.g., in a nominal e-mail client, and views the e-mail message and attached image. The recipient is thus able to act upon to the document, e.g., forward the document, reply to the e-mail message, etc., and can print out the image if desired. The received image is a fully functional fax image which includes the sender's identification information as assigned by the sending fax machine.

An issue which arises with such inbound fax services is that the delivery process of the inbound fax typically ends after the fax image is e-mailed as an attachment to the receiving party's e-mail address or addresses. However, there is absolutely no assurance that actual review of the fax message, in the form of the fax image(s) delivered to the recipient e-mail address or addresses, has occurred. This situation arises, for example, when the recipient is not in the office, the e-mail message is filtered as “spam”, the recipient's mailbox reaches its size limit, the recipient simply forgets to read the e-mail message. When the e-mail message is time-sensitive, there is also no assurance that the recipient has read the e-mail message prior to the deadline for response. By contrast, with a traditional fax machine receiving a facsimile message, the fax machine is a common area where the received documents would highly likely be viewed by someone designated to monitor reception of faxed documents and routed accordingly in a timely manner.

In some situations, even when the fax image has been delivered to the recipient's e-mail address or addresses but not reviewed by the recipient, the recipient and his or her employer may still responsible to properly attend to the fax, i.e., the sender assumes it has been received after the sending fax machine says “Sent” and thus assumes transfer of responsibility to the recipient and his or her employer. Thus, a situation arises where the sender considers the fax message to have been sent and confirmation of reception by the recipient has been provided, yet the recipient has not actually reviewed the fax message.

To rectify this situation, a method in accordance with the present invention modifies the foregoing technique and when implemented by a service provider, provides its clients with assurances that inbound fax messages forwarded via e-mail to recipients are definitely viewed within a certain time frame.

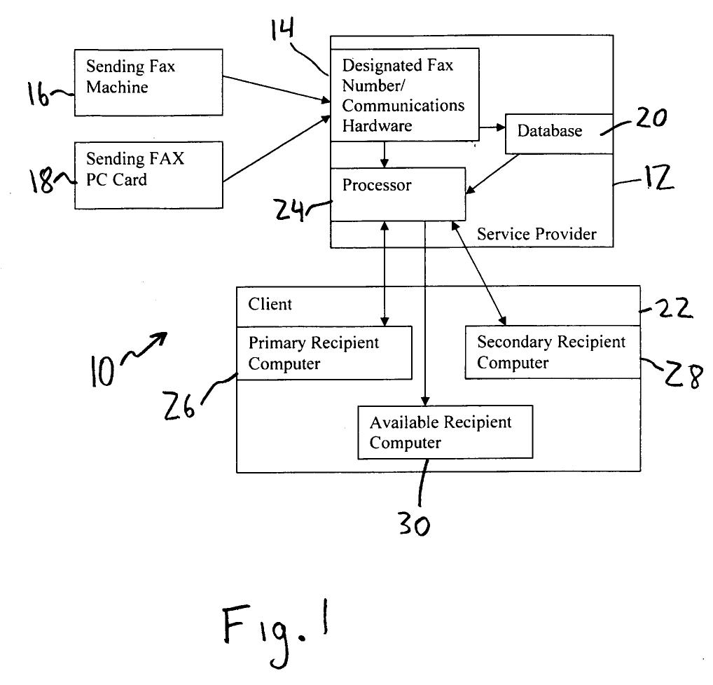

Referring now to FIG. 1, a system in accordance with the invention is designated generally as 10 and includes a service provider 12 which certifies the delivery of fax transmissions to a designated fax number 14 from, for example, a sending fax machine 16 or a sending Fax PC card 18. The manner in which the designated fax number 14 is determined and the manner in which the fax machine 16 and Fax PC card 18 are capable of directing faxes thereto are set forth above.

The service provider 12 is coupled to a database 20 which is capable of associating the designated fax number 14 to one or more e-mail addresses of the intended recipient of the fax transmission, e.g., an employee of the client 22. For example, database 20 may contain a table listing fax numbers on one hand and one or more e-mail addresses on the other. Providing the incoming fax number to the database 20 causes the database 20 to provide the recipient's e-mail address or addresses. A processor 24 is coupled to the communications hardware which handles the fax transmission to the designated fax number 14 and converts the fax transmission into a fax image as described above. The processor 24 is also coupled to the database 20 to receive the recipient's e-mail address or addresses therefrom. The database 20 may be arranged in the same location as the processor 24, or may be at a remote site and connected to the processor 24 via a network. Multiple databases may be provided.

Once the processor 24 has the fax image derived from the facsimile transmission and the intended recipient's e-mail address or addresses, it delivers an e-mail message to each e-mail address of the intended recipient, i.e., to the primary recipient's computer 26.

There are several ways to form the e-mail message based on information from the fax transmission. In one embodiment, an image of the received fax transmission is generated and automatically sent as an attachment with the e-mail message. In an alternative embodiment, an e-mail message is generated which contains details of the fax transmission and a pull link to a server, e.g., one managed by the service provider, but not an attachment with the fax image. In the latter case, a recipient of the e-mail message must activate the pull link, i.e., click on the pull link, in order to request and thereby retrieve the attachment containing the fax image from the server.

The following description relates to the embodiment wherein the e-mail message includes the fax image as an attachment created for example, in the manner described above. The processor 24 records the time at which the e-mail message with attached fax image was delivered and monitors delivery of the e-mail message to the primary recipient's computer 26 to determine whether the primary recipient reads the e-mail message within a maximum allotted time frame (this aspect being described more fully below). If so, a message is generated by the processor 24 indicative of the reading of the e-mail message within the allotted time frame and a report may be generated to provide data about certification of the delivery of the fax message to the client's administrator. If not, the processor 24 delivers the e-mail message to each e-mail address of one or more secondary recipients designated by the primary recipient or client, i.e., to the secondary recipient's computer 28, including the fax image as an attachment. Each of these e-mail messages may include a notification that the primary recipient has not read the e-mail message within the time frame allotted exclusively for the primary recipient to read the e-mail message. The processor 24 then records the time at which the e-mail message was delivered to the secondary recipient and monitors delivery of the e-mail message to both the primary and secondary recipients' computers 26, 28 to determine whether the primary or secondary recipient reads the e-mail message within another maximum allotted time frame. If so, a message is generated by the processor 24 indicative of the reading of the e-mail message within the maximum allotted time frame and a report may be generated to provide data about certification of the delivery of the fax message to the client's administrator.

If the primary and secondary recipients' computers 26, 28 do not indicate to the processor 24 that the primary or secondary recipient has read the e-mail message, then the processor 24 may be programmed to notify an available recipient's computer 30 designated by the client 22 with an indication that both the primary and secondary recipients have not read the e-mail message within the allotted maximum time period. The available recipient can then take any necessary action in response to the fax message attached to the e-mail message. As discussed below, the allotted maximum time frames for the primary and secondary recipients to read the e-mail message may be adjusted in view of the work hours, workdays and vacation schedule of the recipients which is stored in the database 20 or otherwise accessible to the processor 24.

The service provider 12 can include a computer program which handles the communications from the sending fax machine 16 and sending Fax PC card 18 via the telephone network, the communications between the communications hardware which processes the incoming facsimile transmissions to the designated fax numbers 14 and the database 20 and processor 24, the communications between the database 20 and the processor 24 and the communications between the processor, the communications between the processor 24 and the recipient's computers 26, 28, 30. Multiple computer programs may be provided, one resident in the service provider 12 to handle its functions and another present in the client 22 to handle its functions.

The computer programs may be resident on computer-readable media. Computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

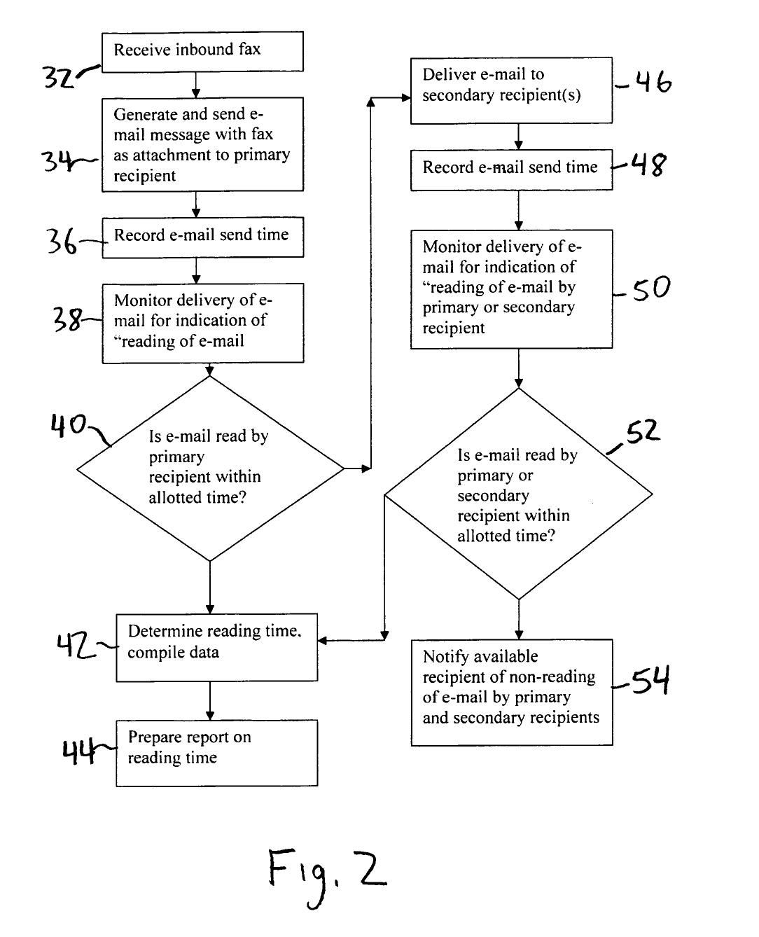

Referring now to FIG. 2, the first step in a method in accordance with the invention to certify the receipt of an inbound fax, which may be accomplished using the structure described above with reference to FIG. 1, includes, receiving an inbound fax 32 and then generating and sending an e-mail message with the fax as an attachment to the primary recipient 34.

As a preliminary step however, an absolute maximum time frame or time-out period (hereinafter referred to simply as a time period) for reading an e-mail message is set. This maximum time period is also considered a failsafe period after which it will be considered that the e-mail message has not been read. Then, a maximum, exclusive allotted time period is determined for the primary recipient to read the e-mail message as well as a maximum allotted time period for a secondary recipient to read the same e-mail message, which would be the portion of this absolute maximum time period after the expiration of the exclusive time period allotted to the primary recipient. The time periods could be set by the client via its administrator and vary depending for example, on the recipients. The client is free to set the maximum time frames as they deem appropriate, although there should be a reasonable maximum time frame. For example, a possible range of a maximum time frame is from about 30 minutes to about 96 hours (4 days). Depending on their own internal policies, the client could select the value most appropriate for their application, i.e., their business field or industry. Since the maximum time frame includes any additional time for a secondary recipient to view the e-mail message, the client could assign a value for this longer period. For example, if a company expects to take action for a received fax message within four hours, they may assign a maximum time frame for each of the primary recipient and a secondary recipient to read the e-mail message of two hours. In this case, the primary recipient would have an exclusive period of two hours to read the e-mail message and then there would be a period of two hours when both the primary and secondary recipients can read the e-mail message. Various factors could influence the maximum time frame and warrant situational variations thereof. Thus, variation of the time frame is envisioned.

Also, as a preliminary step, an available recipient to receive the e-mail message if the primary and secondary recipients do not read the e-mail message is designated by the client via its administrator.

Referring back to FIG. 2, the time at which the e-mail message was sent to the primary recipient is recorded 36 and delivery of the e-mail message for an indication that it has been read is monitored 38. A determination is made 40 as to whether the e-mail message has been read by the primary recipient within a period of time exclusively allotted to the primary recipient to read the e-mail message 40. If so, the reading time is determined and data about the e-mail message is stored, e.g., when it was delivered and when it was read, 42. A report about the delivery of e-mail messages and the reading thereof may then be compiled by the client's administrator 44. Periodic statistics may thus be provided by the service provider to the client about the delivery of fax messages and the certification of the reading thereof, for example, the average time frame to view such messages, the number of alternate addresses that acted on messages, etc.

If the e-mail message has not been read by the primary recipient within a period of time exclusively allotted to the primary recipient to read the e-mail message, then the e-mail message is delivered to a secondary recipient (determined by the processor 24 accessing the database 20) 46 and the time of the delivery is recorded 48. Delivery of the e-mail message to the secondary recipient is monitored for an indication that it has been read 50. A determination is made 52 as to whether the e-mail message has been read by the primary or the secondary recipient within the maximum period of time allotted to read an e-mail message. If so, the reading time is determined and data about the e-mail message is stored, e.g., when it was delivered and when it was read, 42. A report about the delivery of e-mail messages and the reading thereof may then be compiled by the client's administrator 44.

If the e-mail message has not been read by either the primary or the secondary recipient within the maximum period of time allotted to read the e-mail message, then the available recipient is notified 54 that both the primary and secondary recipients did not read the e-mail message within the maximum allotted time period to read an e-mail message.

By ensuring that received e-mail messages derived from inbound fax messages are actually read, or at least viewed, by the intended recipients or an alternate recipient, the recipient's company is protected against the possibility of it indicating reception of a fax message to the sender thereof yet not having any of its employees consider the content of the fax message.

Monitoring delivery of the e-mail messages for an indication that it has been read (steps 38 and 50) may be performed in various ways known to those skilled in the art of confirming reading of e-mail messages. However, one novel way to determine that an e-mail message has been read in accordance with the invention is based on the fact that e-mail clients and systems generally accept messages into the user's mailbox and either download them to the user's PC or present summary information (such as To, From, Subject and/or Time received) for all messages. The e-mail system typically enables the user to control which e-mail messages are viewed and the manner in which they are viewed, regardless of whether the e-mail messages are derived from inbound fax messages or traditional e-mail messages. Note though that this information is for the recipient and thus not provided to the sender of the fax message from which the e-mail message has been derived. Indeed, the sender of the fax message may not be notified that the fax message has been converted into an e-mail message with the fax message as an attachment thereof. Also, the sender would merely received acknowledgement of the delivery of the fax message to the designated fax number. Although some e-mail systems include an option referred to as “Return receipt request” which allows the e-mail sender to request that the recipient's e-mail system automatically or manually send a notification back to the sender when the message has been viewed, this option is not available on all e-mail systems, and preferably is not used in the invention. Moreover, such an option only indicates receipt of an e-mail message and not that it has been read.

E-mail messages generally consist of text characters (usually 7 or 8 bit ASCII). Even HTML e-mail messages and attachments are sent using only ASCII characters. Images within the e-mail message (such as logos and small pictures) are usually referenced in the messages by links to their location on one or more web sites. When reading an e-mail message, the e-mail client activates the links and thereby accesses these images from the web sites via the Internet and places them in the relevant location inside the message, typically when the message is first viewed.

It has become common practice in the e-mail industry to incorporate additional unique information in these image links, which allow the web sites which provide the images to identify the requestor of each image. This is commonly known as “open bugs” and this process is a preferred manner to enable a determination of the time when the recipient actually opens or reads an e-mail message in accordance with the invention. Basically, the activation of a link in an e-mail message which requests an image from a web site is considered an indication that the recipient has read the e-mail message.

The use of open bugs is well-known and as a result, many e-mail clients will not load such images, unless the recipient has placed the sender of the e-mail message on a list of acceptable senders or a “warning bar” on the e-mail client is activated to allow access to these images. When the invention is therefore implemented by a service provider for its clients, the presence of such e-mail clients requires that the clients agree to inform its users, i.e., the recipients, to add the service provider's sending address to the list, and/or to always click on the “warning bar” to download the images.

Additionally, an issue arises when the e-mail message does not include any images, i.e., is plain text only. In this case, the service provider inserts a URL link into the e-mail message which when clicked, will provide the “read” information that would otherwise be provided when the e-mail client activates links to images. This URL should have a text that indicates that the reader must click on it in order to comply with the terms of the fax delivery service agreement and indicate review of the e-mail message. An example of such text would be “Click here to indicate you have viewed this message”.

The foregoing enables an indication to be provided to the service provider when a recipient has viewed an e-mail message (derived from a facsimile transmission to a designated telephone number), whether the recipient is the primary recipient or a secondary recipient. Records may be kept containing data about when each recipient has viewed their e-mail messages, via activation of one or more links by the e-mail client of their computer in order to access images from a web site or via activation of a dedicated link in the case of a plain text e-mail message. However, there is not believed to be any analysis of the failure to activate a link in an e-mail message delivered to a recipient. Such is provided by the present invention.

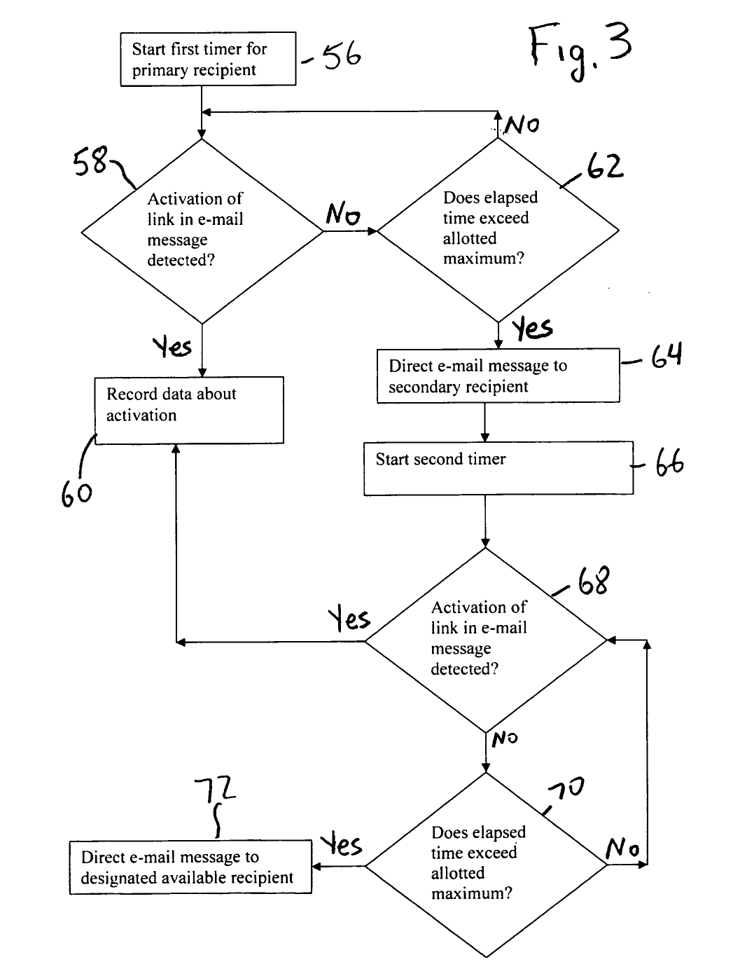

In this regard, referring to FIG. 3, a novel technique for detecting failure to activate a link in an e-mail message is provided. This technique is implemented in conjunction with the steps of monitoring the delivery of e-mail messages for an indication of the primary or secondary recipients reading the e-mail messages (steps 38, 40, 50, 52 in FIG. 2).

Thus, after recording the send time of the e-mail message to the primary recipient (step 36 in FIG. 2), a first timer is started 56 and a determination is made 58 whether a link in the e-mail message has been activated, e.g., whether a request for an image has been received at a web site accessible by the computer at the service provider managing the certification of facsimile message delivery. If so, data about the activation is recorded 60, this data being used to compile information about certification of e-mail message delivery which can be reviewed by the client. However, if the link is not activated, then a determined is periodically made 62 as to whether a maximum time frame has been elapsed (by monitoring the current time relative to the start time), this periodic determination being illustrated via a loop from 62 to 58. If the recipient does not activate a link in the e-mail message within the maximum time frame, then a copy of the e-mail message is delivered to a secondary recipient (or recipients) 64.

Upon delivery of the copy of the e-mail message to each secondary recipient, another timer is started 66, i.e., at the time of delivery of the e-mail message to the secondary recipient, and a determination is made 68 whether a link in either the e-mail message delivered to the primary recipient or the e-mail message delivered to the secondary recipient has been activated. If so, data about the activation is recorded 60. However, if the link is not activated, then a determined is periodically made 70 as to whether a maximum time frame has been elapsed (by monitoring the current time relative to the start time of the second timer), this periodic determination being illustrated via a loop from 70 to 68. If either of the primary and secondary recipients does not activate a link in the e-mail message within the maximum time frame, then a copy of the e-mail message is delivered to a pre-designated available recipient (or recipients) 72. Alternative additional action to take when the primary and secondary recipients both do not read the e-mail message within the absolute maximum time frame may entail sending the e-mail message to a supervisor's e-mail address, initiating a communications to the primary recipient via other means, e.g., by telephone and/or notifying the sender that the e-mail message, although received, has not been read.

The maximum time frame for both the primary and secondary recipients to read the e-mail message and thereby activate the link, may be the same as or different than the maximum time frame allotted exclusively for the primary recipient to read the e-mail message. This is possible because after delivery of the copy of the e-mail message to the secondary recipient or recipients, the original e-mail message is still in the mailbox of the primary recipient. Therefore, the primary recipient can still view the e-mail message within the extended time frame which is a combination of their exclusive time frame (before the copy of the e-mail message is delivered to the secondary recipient or recipients) and the supplemental time frame (when both the primary recipient and the secondary recipient(s) have received the e-mail message).

Variations to the above method are envisioned.

In one embodiment, if the primary recipient does not indicate that he or she has read the e-mail message within a predetermined period of time, then the service provider notifies the primary recipient of the inbound fax message in a different manner, for example, to send a new copy of the e-mail message derived from the inbound fax message to one or more pre-designated alternate e-mail addresses. Monitoring delivery of the e-mail message to the primary recipient would therefore additionally entail monitoring the alternate e-mail address(es).

In another embodiment, the maximum time frame for the primary and/or secondary recipient to read the e-mail message is adjusted in consideration of normal business hours and/or vacation periods for the recipients. That is, the maximum, exclusive time frame for the primary recipient to read the e-mail message and the maximum time frame for both the primary and secondary recipients to read the e-mail message preferably account for the time when the recipients are expected to be working. Thus, if a company expects its employees to take action for a received fax message within four hours (two hours allotted exclusively to the primary recipient and another two hours for the secondary recipient(s)), it normally means business hours so that if a fax is received at 2 AM, it would not want the additional action undertaken after non-responsiveness by both the primary and secondary recipients to occur at 6 AM (assuming a four hours absolute maximum time period). A method in accordance with the invention therefore allows for the client to set, maintain and change if necessary, its normal business hours and workdays, and holiday schedule. As such, only hours when the business is open and the recipients are expected to be working would count against the time frame.

Thus, if a timer were to start monitoring the reading of an e-mail message and the business then closes before the maximum time period elapses, the timer would pause and continue only at the start of the next business day.

Management of the parameters of the certification of the delivery of e-mail messages, including those derived from fax messages in the manner described above, may be conducted via a web site which interfaces with the e-mail client and the computer program at the service provider running the e-mail message delivery certification process. In a preparatory stage, the administrator for the client, possibly with the assistance of the service provider, accesses the web site and enters default parameters, such as the normal business hours and workdays of the client and its employees, particular business hours of certain employees of the client if different than the normal business hours of the client, a holiday schedule, and the maximum time frame for reading of an e-mail message which would be portioned into the maximum time period for a primary recipient to view an e-mail message, and the maximum time frame for a secondary recipient to view an e-mail message. The administrator could also select and/or define primary and alternate templates used when reporting on the certification of the delivery of e-mail messages derived from fax messages, and provide e-mail addresses to which the fax messages should be sent, i.e., a lookup table associating each incoming fax number with one or more e-mail addresses. Using the web site, each employee can also provide the e-mail address or addresses they want their e-mail messages derived from inbound fax messages to be sent to and also designate one or more secondary recipients. Once this has been accomplished, the administrator does not need to access this web site, except to make any required changes in such settings.

When a change is desired, the administrator, or certain or all employees, can access the web site and decide whether to use or maintain the default parameters for each employee, and maintain or change the e-mail addresses. If so, the employee's parameters are set to the default parameters. Otherwise, the administrator or employee is presented with an option to change the parameters and enters new parameters, e.g. the maximum time frame, different vacation days different business hours and the like, which are then set as the employee's parameters. For example, when an employee knows specific days he/she will be out of the office on vacation, they could access the web site and enter those days into the vacation day option. In this case, they may also enter a “vacation” addressee who will be receiving inbound fax messages (in the form of an e-mail message as described above) as a primary recipient during their vacation period. The employee can also select a different template (vacation template) for the vacation addressee which informs that individual that he or she is receiving a fax message for an employee on vacation. The vacation addressee should not be the secondary recipient.

When implemented, during the vacation period, the system sends inbound fax messages to both the vacation addressee and the original user (who is on vacation). This allows the original recipient to see which fax messages were received during the vacation period, and who and when these messages were viewed (for example, using the ticker image described below).

In some embodiments, employees are not given the ability to change the maximum time frames so that a uniform maximum time frame may be provided for all employees of the company, which maximum time frame is set by the administrator. However, the employee could be provided with the ability to decrease the maximum time frame if they so desire.

Another significant variation of the technique described above relates to the manner in which recipients are notified of the prior reading of an e-mail message by another recipient in a situation where the e-mail message has been delivered to multiple recipients. For example, during the time when both the primary and secondary recipients have the e-mail message in their mailbox, it would be preferable to notify the primary recipient if the secondary recipient has previously read the e-mail message to avoid unnecessary action by the primary recipient and vice versa, since the first reader would be considered as the person responsible for action responsive to the e-mail message.

As described above, if the primary recipient does not read the e-mail message within the maximum exclusive time frame allotted for the primary recipient to read the e-mail message, then the e-mail message is also sent to at least one secondary recipient, with this secondary recipient having an allotted maximum time frame to read the e-mail message. However, during the maximum time frame that the secondary recipient can read the e-mail message, the primary recipient can also read the e-mail message. As such, a situation may arise where both the primary recipient and a secondary recipient read the e-mail message and take a responsive action. The same situation may arise when the e-mail message is sent to a plurality of primary recipients.

In one embodiment of the invention, this situation is addressed whereby all recipients of the e-mail message are notified about responses by any other recipient of the same e-mail message. The lack of an indication about a response from any other recipient being provided to one recipient is indicative that if that recipient responds, he or she will be the first to respond.

To implement this feature, a formatted e-mail message is used. The formatted e-mail message is a template, e.g., selected by the client or its administrator, which provides relevant information about the fax message, such as one or more of the following: the date/time received, the sender's fax machine identifier, the inbound fax number called, the primary recipient's name, the number of pages in the fax, the duration of the fax call, the received fax status, the fax resolution, the fax transmission speed, the fax attachment file type, the primary recipient's e-mail address, a tracking number and a Fax ID message number. The original document fax image is included as an attachment. As noted above, the e-mail message would include at least one link which must be activated to indicate that the primary recipient has read the e-mail message. For example, the template might contain a statement to the effect that an image in the e-mail message must be clicked in order to be displayed to indicate that the primary recipient has opened the e-mail message and further, that if the image is not displayed (because pictures and images may be blocked by the e-mail client to prevent the sender from identifying the computer), the primary recipient must click a link to allow the e-mail client to display the image. The template would also contain an indication of the date and time that the e-mail message is delivered to the primary recipient (which starts a timer as discussed above).

One template, referred to as a primary template, is used when the e-mail message is initially sent to the primary recipient. At this time, the primary recipient is the only recipient of the e-mail message and therefore does not need to be notified that anyone else has read the e-mail message because no one else has even received the e-mail message.

Thereafter, if the primary recipient does not read the e-mail message with the maximum exclusive time period, a copy of the e-mail message would be sent to an alternate e-mail address (of a secondary recipient). This copy of the e-mail message has a different, secondary template which notifies the secondary recipient that they are receiving the message because the primary recipient failed to read the message within the maximum exclusive time period. Thus, the secondary template would include a noticeable indication to this effect, for example, a statement that “The primary recipient of this fax message may not have opened this message in the time period allowed. You are receiving this notification as an alternate recipient”. The secondary template may include any or all of the items as in the primary template listed above.

At this time, the primary recipient has an e-mail message with the primary template in their mailbox (or mailboxes if they designated multiple e-mail addresses to receive incoming fax messages) and each secondary recipient also has an e-mail message having the secondary template in their mailbox (or mailboxes if multiple e-mail addresses were designated).

The invention therefore implements a novel technique for notifying any of the primary or secondary recipients as soon as one of the recipients reads the e-mail message. A basic technique would be to generate and send a follow-up e-mail message to all of the recipients (other than the first responding recipient) listing the first e-mail address to open the message. One drawback of this approach is that each recipient would have to open the subsequently sent e-mail messages and keep track on which e-mail message was being acknowledged.

A preferred approach is based on the recognition that the e-mail messages (both those sent to the primary recipient and secondary recipient(s)) contain at least one activatable link to an image that was used to determine when and who opened the e-mail message. This link would display the image inside the message and required the reader to take an action, e.g., click on the image, in order to retrieve the image from a web site with the transmission of the image being recorded and considered an indication of the e-mail message having been read by the recipient of the e-mail message requesting the image, with the date and time of the request being noted. Most links currently used for this purpose (the open bug) are transparent one pixel by one pixel wide blanks, and do not actually display any visible indication within the message.

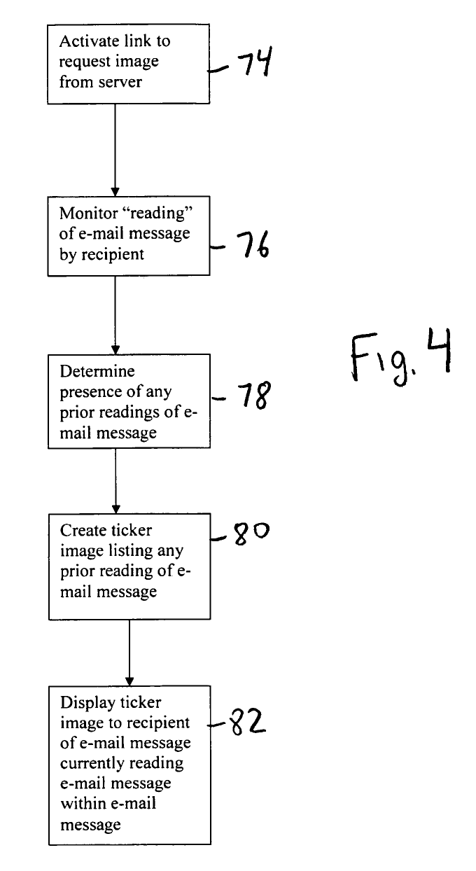

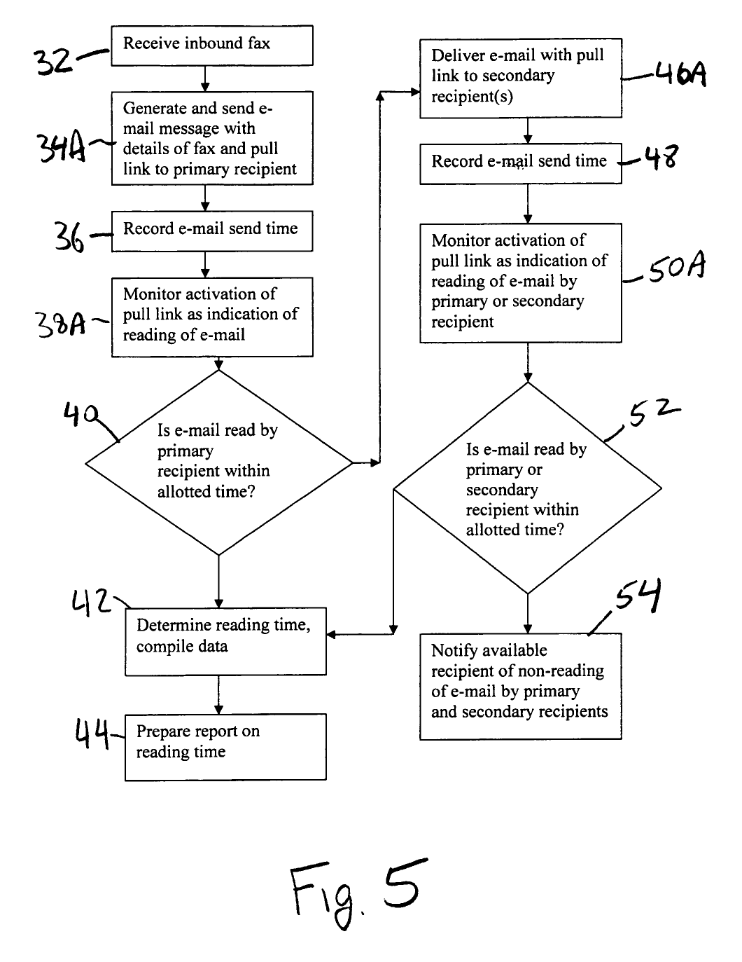

Referring to FIG. 4, in accordance with the invention however, when a link in an e-mail message is activated by any recipient receiving the e-mail message, which has been delivered to multiple recipients, and the e-mail client requests an image from the server of the service provider 74, the request for the image is monitored 76 in the manner described above, e.g., by detecting the time and date the image is being requested. The presence of a reading of the same e-mail message by another recipient at a prior time is determined 78, which data may be stored in a database of the service provider. Thereafter, a unique “ticker” image is created 80 and displayed to the recipient currently reading the e-mail message in the e-mail message previously delivered, but not yet read 82. The ticker image is not a specific pre-existing image but rather is created only when the link in the e-mail message is activated and therefore is able to provide information about any and all prior “readings” of the e-mail message. The ticker image may be a full image, and in one embodiment, is a text message which is converted to an image file (JPEG or GIF) and sent to the e-mail client upon activation of a link in the e-mail message. The primary function of the ticker image is to notify the recipient about the existence of previous readings of the same e-mail message, e.g., whether the recipient is the first to read the e-mail message or whether one or more other recipients have already read the same e-mail message.

Since it is created by the service provider only when a link in the e-mail message is activated, the ticker image is updated as each additional recipient opens the message. As a result, it becomes possible to supply current information in an e-mail message delivered at an earlier time. This is an important and novel aspect of the invention since generally it is not possible to change an e-mail message once sent. However, by including an activatable link in the e-mail message and generating the ticker image upon activation of the link and directing the ticker image to the e-mail client to be included in the e-mail message, it now becomes possible to bring a previously delivered e-mail message up-to-date and reflect activity relating to the e-mail message which occurred after its delivery.

The ticker image starts with the current date/time stamp that is the exact time the image has been requested by the e-mail client. The ticker image would also include a current list of all recipients who have viewed the message, with the first viewer named at the top of the list.

An example of the ticker image for the first recipient to read the e-mail message might be as follows:

“Your time is (dated and time)

You just acknowledged receipt of this fax message.

List of users who have already opened the same fax message:

1. E-mail: Larry at hotmail cohen_larry@ hotmail.com at (date and time)

You are the first to open the fax message”.

An example of the ticker image for the secondary recipient to read the e-mail message might be as follows:

“Your time is (dated and time)

You just acknowledged receipt of this fax message.

List of users who have already opened the same fax message:

1. E-mail: Larry at hotmail<cohen_larry@ hotmail.com>at (date and time)

2. E-mail: Harry at Verizon>harry12409@ verizon.net>at (date and time)

Upon receiving such a ticker image, Harry would see Larry's name as the first to open the e-mail message and would therefore be easily notified that he is not the first to open the e-mail message. Larry could therefore inquire as to whether Harry responded to the e-mail message and avoid duplicate responses to the same e-mail message.

The use of ticker image to convey information in an e-mail message which occurred after the delivery of the e-mail message may be applied in situations other than in connection with the certification of delivery of a fax message as described above. Indeed, the technique for generating a ticker image via an activatable link in an e-mail message may be applied in any type of e-mail message management technique, regardless of the manner in which the e-mail message has been created.

In the embodiment wherein the e-mail message contains a pull link, activation of the pull link, i.e., requesting the fax image from the server, is considered reading of the e-mail. Use of a pull link in an e-mail message which must be activated in order to view the fax image provides a significant benefit in that it becomes possible to deliver the fax image only to the first reading recipient, whether it is a primary or a secondary recipient. This is particularly advantageous for clients with numerous primary and/or secondary recipients, all of whom would initially receive the same e-mail message with a pull link, and want only the first of these recipients to activate the pull link and thereby receive the actual fax image. This would avoid a situation where multiple recipients read and respond to the same fax transmission.

In a situation with multiple primary recipients, the server would monitor the e-mail messages delivered to all of the primary recipients for activation of the pull link, and would know which primary recipient is requesting the fax image, i.e., which primary recipient activates the pull link before any other primary recipient. For the first request by a primary recipient for the fax image arising from activation of a pull link, the server downloads the fax image directly to that primary recipient. However, for any additional requests for the same fax image, i.e., subsequent activations of the pull link in the same e-mail message, the server could be arranged to present an HTML page or message with the same information as would be in the ticker image, that is, the status of which recipient first requested the fax image from the server, the date and time of the request, the status of a response to the fax image etc. This HTML page or message could also contain an additional pull link to download the message, so the other recipients could, if desired, retrieve another copy of the fax image (or the first recipient could click this link to get a second copy, etc.).

The invention is described above applying a primary recipient and one or more secondary recipients. The invention may also be applied to tertiary and subsequent recipients. That is, if the primary recipient does not read the e-mail message with an exclusive allotted time, and the primary and secondary recipients do not read the e-mail message within another allotted period of time, then the e-mail message may be sent to a tertiary recipient for an allotted period of time in which any of the recipients may read the e-mail message. If none of the recipients read the e-mail message within the maximum allotted period of time, then the available recipient is notified. The maximum allotted period of time may be segmented between the primary, secondary and tertiary recipients as desired.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention.

1. A method for monitoring delivery of e-mail messages, comprising:
delivering an e-mail message to a primary, intended recipient;
determining the time at which the e-mail message was delivered to the primary recipient;
determining whether the primary recipient reads the e-mail message within a primary maximum time frame;
when the primary recipient does not read the e-mail message within the primary maximum time frame, then
delivering a copy of the e-mail message to at least one secondary recipient;
determining the time at which the e-mail message was delivered to each of the at least one secondary recipient; and
determining whether any of the least one secondary recipient reads the e-mail message within a secondary maximum time frame; and
when both the primary and secondary recipients do not read the e-mail message within the secondary maximum time frame, then notifying an available recipient of the non-reading of the e-mail message by the primary and secondary recipients to enable the available recipient to attend to facilitating a response to the e-mail message.

2. The method of claim 1, further comprising forming the e-mail message from a facsimile message sent to a facsimile number assigned to the primary recipient.

3. The method of claim 1, wherein the steps of determining whether the primary and secondary recipients read the e-mail message comprises placing at least one activatable link in the e-mail message which is activated when any of the primary and secondary recipients reads the e-mail message and detecting the activation of the at least one link.

4. The method of claim 3, wherein the at least one link is a link for requesting an image from a web site which is required to read the e-mail message, the date and time at which the image is requested from the web site being considered the date and time when the e-mail message is read.

5. The method of claim 3, wherein the at least one link in the e-mail message is automatically activated when the primary or secondary recipient reads the e-mail message.

6. The method of claim 3, wherein the at least one link in the e-mail message must be manually activated by the primary or secondary recipient when reading the e-mail message.

7. The method of claim 1, further comprising determining work hours for the primary recipient, wherein the step of determining whether the primary recipient reads the e-mail message within the primary or secondary maximum time frames comprises considering only work hours of the primary recipient in the primary or secondary maximum time frame.

8. The method of claim 1, further comprising determining work hours for each of the at least one secondary recipient, wherein the step of determining whether any of the at least one secondary recipient reads the e-mail message comprises considering only work hours of each of the at least one secondary recipient in the secondary maximum time frame.

9. The method of claim 1, further comprising:
establishing a combined maximum time frame for reading of the e-mail message by the primary and secondary recipients; and
partitioning the combined maximum time frame into the primary and secondary time frames.

10. The method of claim 1, further comprising:
creating a web site for managing the delivery of the e-mail messages to the primary and secondary recipients; and
enabling access to the web site to enable e-mail message delivery parameters of the primary and secondary recipients to be entered.

11. The method of claim 1, further comprising including with the copy of the e-mail message being delivered to each of the at least one secondary recipient an indication that they are receiving the e-mail because the primary recipient did not read the e-mail.

12. The method of claim 1, wherein the e-mail address is delivered to a first e-mail address of the primary recipient, further comprising:
when the primary recipient does not read the e-mail message within the primary maximum time frame, then delivering the e-mail message to an alternate e-mail address of the primary recipient.

13. The method of claim 1, further comprising:
determining if the primary recipient is on vacation; and if so, cotemporaneous with the delivery of the e-mail message to the primary recipient, delivering the e-mail message to an alternate recipient designated by the primary recipient.

14. The method of claim 1, further comprising notifying each of the primary and secondary recipients of reading of the e-mail message by another recipient during the time when the e-mail message has been delivered to the primary and secondary recipients, each of the primary and secondary recipients being notified when they read the e-mail message.

15. The method of claim 14, wherein the step of notifying each of the primary and secondary recipients of prior reading of the e-mail message comprises:
inserting an activatable link in the e-mail message; and
creating a ticker image in the e-mail message only after the link is activated which indicates the status of reading of the same e-mail message by any other recipients thereof.

16. The method of claim 1, further comprising:
forming the e-mail message based on information in a facsimile message sent to a facsimile number assigned to the primary recipient; and
converting the facsimile message to an e-mail attachment which is not provided automatically with the e-mail message,
the steps of determining whether the primary and secondary recipients read the e-mail message comprising the step of placing an activatable link in the e-mail message which requires a recipient of the e-mail message to activate the link in order to access the attachment whereby activation of the link is considered reading of the e-mail message.

17. The method of claim 16, wherein the same e-mail message is delivered to a plurality of primary recipients, further comprising providing the attachment to only the first recipient activating the link in the e-mail message.

18. The method of claim 17, further comprising:
notifying each recipient of the e-mail message of prior activity relating to the e-mail message by any other recipients when they activate the link; and
enabling each recipient after the first recipient to receive the attachment upon request.

19. A method for monitoring delivery of e-mail messages, comprising:
delivering the same e-mail message to multiple recipients such that the recipients are able to read the e-mail message at the same time; and
providing notification in the e-mail message to each of the recipients of prior reading of the e-mail message by another recipient.

20. The method of claim 19, wherein the step of providing notification to each of the recipients of prior reading of the e-mail message comprises:
inserting an activatable link in the e-mail message; and
creating a ticker image in the e-mail message only after the link is activated which indicates the status of reading of the same e-mail message by any other recipients thereof.

21. A method for monitoring delivery of e-mail messages, comprising:
delivering an e-mail message to a primary, intended recipient;
determining the time at which the e-mail message was delivered to the primary recipient;
determining work hours for the primary recipient;
determining whether the primary recipient reads the e-mail message within a primary maximum time frame;
considering only work hours of the primary recipient in the primary maximum time frame; and
when the primary recipient does not read the e-mail message within the primary maximum time frame, taking additional action to enable reading of the e-mail message by an alternate recipient.

22. The method of claim 21, wherein the step of taking additional action comprises:
delivering a copy of the e-mail message to at least one secondary recipient;
determining the time at which the e-mail message was delivered to each of the at least one secondary recipient; an
determining whether any of the least one secondary recipient reads the e-mail message within a secondary maximum time frame; and
when both the primary and secondary recipients do not read the e-mail message within the secondary maximum time frame, then notifying an available recipient of the non-reading of the e-mail message by the primary and secondary recipients to enable the available recipient to attend to facilitating a response to the e-mail message.

23. The method of claim 21, further comprising forming the e-mail message from a facsimile message sent to a facsimile number assigned to the primary recipient.

24. The method of claim 21, wherein the steps of determining whether the primary recipient reads the e-mail message comprises placing at least one activatable link in the e-mail message which is activated when the primary recipient reads the e-mail message and detecting the activation of the at least one link.

25. A computer program resident on computer-readable media and arranged to monitor delivery of e-mail messages, the computer program being arranged to:
deliver an e-mail message to an e-mail client of a primary, intended recipient's computer;
determine the time at which the e-mail message was delivered to the primary recipient's computer;
determine whether the primary recipient reads the e-mail message within a primary maximum time frame;
when the primary recipient does not read the e-mail message within the primary maximum time frame, then
deliver a copy of the e-mail message to an e-mail client of at least one secondary recipient's computer;
determine the time at which the e-mail message was delivered to each of the at least one secondary recipient's computer; and
determine whether any of the at least one secondary recipient reads the e-mail message within a secondary maximum time frame; and
when both the primary and secondary recipients do not read the e-mail message within the secondary maximum time frame, notify an available recipient of the non-reading of the e-mail message by the primary and secondary recipients to enable the available recipient to attend to facilitating a response to the e-mail message.

26. The computer program of claim 25, wherein the computer program is maintained by a service provider and the primary and secondary recipients are employees of a client of the service provider.

27. The computer program of claim 25, wherein the computer program is further arranged to interface with communications hardware having an assigned facsimile number for the primary recipient, associate the assigned facsimile number with at least one e-mail address of the primary recipient and convert an incoming facsimile transmission into an e-mail message for the primary recipient to be delivered to the at least one e-mail address of the primary recipient.

28. A computer program resident on computer-readable media and arranged to monitor delivery of e-mail messages, the computer program being arranged to:
deliver the same e-mail message to an e-mail client of multiple recipients' computer such that the recipients are able to read the e-mail message at the same time; and
provide notification in the e-mail message to each of the recipients of prior reading of the e-mail message by another recipient.

29. The computer program of claim 28, wherein the computer program interfaces with an e-mail client of each recipient and delivers the e-mail message to the e-mail client for placement in the mailbox of each recipient, the computer program being arranged to provide notification to each of the recipients of prior reading of the e-mail message by:
inserting an activatable link in the e-mail message; and
creating a ticker image in the e-mail message only after the link is activated which indicates the status of reading of the same e-mail message by any other recipients thereof.

30. A computer program resident on computer-readable media and arranged to monitor delivery of e-mail messages, the computer program being arranged to:
deliver an e-mail message to an e-mail client of a primary, intended recipient's computer;
determine the time at which the e-mail message was delivered to the primary recipient's computer;
store work hours for the primary recipient;
determine whether the primary recipient reads the e-mail message within a primary maximum time frame while considering only work hours of the primary recipient in the primary maximum time frame; and
when the primary recipient does not read the e-mail message within the primary maximum time frame, take additional action to enable reading of the e-mail message by an alternate recipient.

31. The computer program of claim 30, wherein the computer program is maintained by a service provider and the primary recipient is an employee of a client of the service provider.

32. The computer program of claim 30, wherein the computer program is further arranged to interface with communications hardware having an assigned facsimile number for the primary recipient, associate the assigned facsimile number with at least one e-mail address of the primary recipient and convert an incoming facsimile transmission into an e-mail message for the primary recipient to be delivered to the at least one e-mail address of the primary recipient.

33. A system for monitoring delivery of e-mail messages derived from facsimile messages, comprising:
communications hardware which has at least one designated fax number and receives facsimile transmissions;
at least one database including data about e-mail addresses of possible recipients of facsimile transmissions; and
a processor coupled to said communications hardware and said at least one database and arranged to convert each facsimile transmission into an e-mail message and deliver the e-mail message to at least one e-mail address of an intended, primary recipient of the facsimile transmission obtained from said at least one database;
said processor being arranged to record the time at which the e-mail message was delivered, determine whether the primary recipient reads the e-mail message within a maximum first time frame, if not, deliver a copy of the e-mail message to at least one secondary recipient, record the time at which the e-mail message was delivered to the at least one secondary recipient, determine whether the primary or secondary recipient reads the e-mail message within a maximum second time frame, and if not, notify an available recipient of the lack of reading of the e-mail message by both the primary and secondary recipients.

34. The system of claim 33, wherein said communications hardware, said at least one database and said processor are maintained by a service provider and the primary and secondary recipients are employees of a client of the service provider.
